(19) United States
(12) Patent Application Publication
(10) Pub. No.: US 2010/0315535 A1
(43) Pub. Date: Dec. 16, 2010

(54) REDUCING POWER CONSUMPTION IN A PORTABLE ELECTRONIC DEVICE WITH A LUMINESCENT ELEMENT

(75) Inventors: Vincent Nurit, Fenouillet (FR); Sylvain Monfils, Cugnaux (FR); Stephane Richaud, Longages (FR)

Correspondence Address: LARSON NEWMAN & ABEL, LLP, 5914 WEST COURTYARD DRIVE, SUITE 200, AUSTIN, TX, 78730, US

(73) Assignee: FREESCALE SEMICUNDUCTOR, INC., Austin, TX (US)

(21) Appl. No.: 12/866,247

(22) PCT Filed: Feb. 13, 2008
(86) PCT No.: PCT/IB2008/051781

§ 371 Date: Aug. 5, 2010

(51) Int. Cl. H04N 9/68

(52) U.S. Cl. 348/234; 348/E09.053

(57) ABSTRACT

A portable device including at least one luminescent element, a camera including an image sensor for activation to produce an electrical image signal representative of an image sensed by the image sensor, and a camera signal processor including a camera memory for storing the image signal for subsequent reproduction of the image, the device also including a luminescence controller for controlling a brightness of the luminescent element, the camera signal processor is also arranged to activate the image sensor intermittently to produce sample signals representative of ambient light during periods in which the image signal is not being stored in the camera memory, the luminescence controller being responsive to the sample signals to modulate progressively the brightness of the luminescent element as a function of a brightness of ambient light. In a portable device including at least one luminescent element, a plurality of human-interface actuators, at least one sensor responsive to an ambient variable relating to usage of the device, a timer and an activation controller for controlling activation and deactivation of the luminescent element, the activation controller is responsive to different conjunctions of signals from the actuators, the sensor and the timer to activate selectively and to extinguish the luminescent element, whereby to economise power consumption of the luminescent element when the conjunction of signals is indicative of user inactivity of the device.

### FIELD OF THE INVENTION

This invention relates to a portable device including at least one luminescent panel and a camera.

### BACKGROUND OF THE INVENTION

Portable devices often include luminescent panels as backlights to illuminate human interface actuators, especially keyboards, for example, and as display screens for data and operating parameters or as backlights for display screens. An example of the latter kind of display screen is a liquid crystal display (‘LCD’) screen where an image to be displayed is formed in a layer of liquid crystal material by applying electric signals to electrodes in a matrix of elementary pixels. While such a display can be seen by reflection of ambient light from a reflecting surface behind the LCD layer, visibility and appearance are much improved in many viewing conditions by providing a backlight, for example in the form of a luminescent layer such as an array of light-emitting diodes (‘LEDs’) to illuminate the LCD screen. While an LCD layer itself consumes relatively little power, luminescent panels such as a backlight layer can consume considerably more.

Many portable devices use luminescent display screens. Examples are devices functioning as portable telephones, cameras, especially digital cameras and personal digital assistants. Often a single device incorporates two or more of such functions, in which case one or more backlight display screens and their drivers may be used in common for displaying data or images from the different functions alternatively. This avoids duplicating expensive components and their power consumption. For example, a portable telephone with a digital camera incorporated may have a luminescent display screen to display data relating to operation and commands of the telephone, data relating to operation and commands of the camera, and an image taken by the camera function; the different displays on the common screen are usually wholly or partially alternatives. The usage of a common display screen and driver in this way avoids duplicating expensive components and their power consumption.

Ways are known of reducing power consumption in portable devices with luminescent display screens. For example, international patent specification WO1993/023842 describes a display device with an electroluminescent panel for lighting the display, the device using the electroluminescent panel to sense ambient light and controlling the electroluminescent panel to light the display when the ambient light is below a threshold but being extinguished when the ambient light is above the threshold. Also, backlight dimmers exist which control the brightness of a display as a function of ambient light as sensed by ambient light sensors. Such systems offer reductions in power consumption.

### SUMMARY OF THE INVENTION

The present invention provides a portable device including a luminescent panel as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale.

FIG. 1 is a simplified sectional view of a portable telephone device,

FIG. 2 is a schematic diagram of electronic signal processing modules in the telephone of FIG. 1,

FIG. 3 is a schematic diagram of a backlight control module in the telephone of FIG. 1 in accordance with one embodiment of the invention, given by way of example,

FIG. 4 is a schematic diagram of a backlight control module in the telephone of FIG. 1 in accordance with another embodiment of the invention, given by way of example,

FIG. 5 is a graph of backlight intensity and power consumption as a function of ambient light with the backlight control modules of FIGS. 3 and 4,

FIG. 6 is a graph of power consumption as a function of time with the backlight control module of FIG. 4, and

FIG. 7 is a schematic flowchart of operation of the telephone of FIG. 1 with the backlight control module of FIG. 3 or 4.

### DETAILED DESCRIPTION OF THE PREFERRED EMBODIMENTS

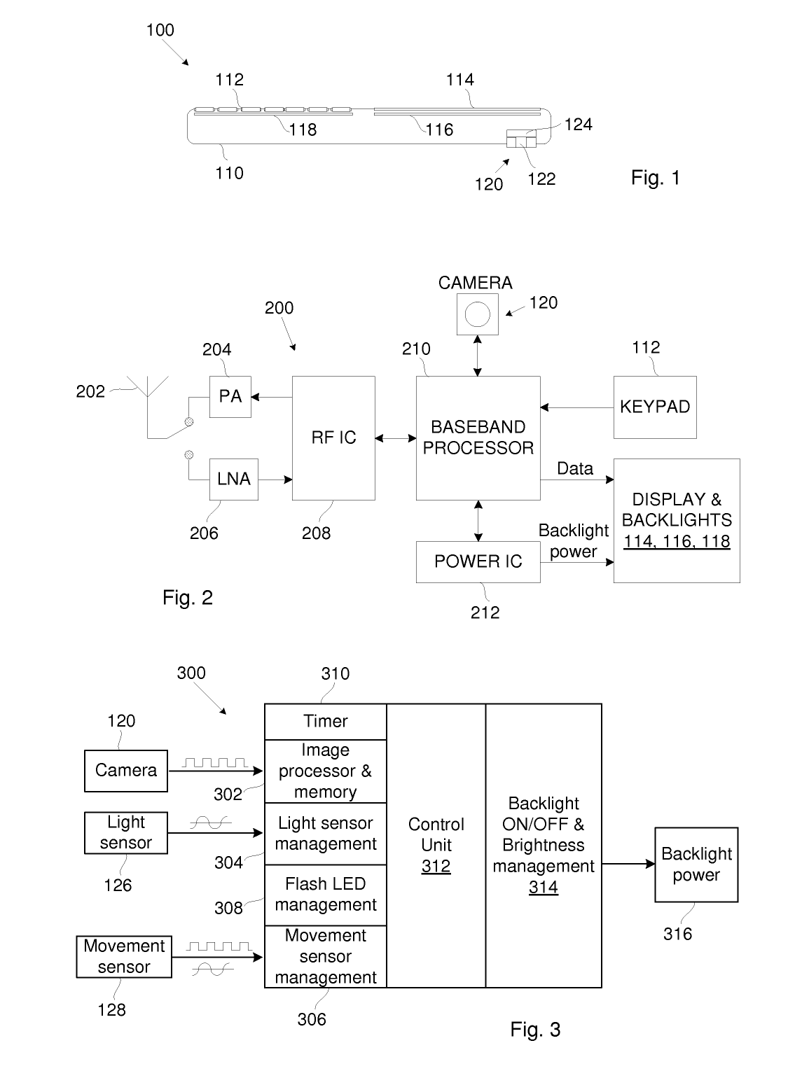

FIG. 1 shows a portable telephone 100 comprising a casing 110, a keypad comprising an array of keys 112 that forms a human interface by which a user can input data to the telephone. The telephone also comprises a display screen 114 in the form of a liquid crystal display (‘LCD’) panel, a first luminescent element in the form of a luminescent panel 116 juxtaposed behind the display screen 114 in order to illuminate the panel as a backlight and a second luminescent element in the form of another luminescent panel 118 juxtaposed behind the keypad 112 in order to illuminate the keypad as a backlight. The telephone also includes a digital camera 120 comprising a lens 122 for focussing an image onto an image sensor 124 to produce an electrical image signal representative of the image.

As shown in FIG. 2, the electronic signal processing modules 200 of the telephone 100 comprise an antenna 202, a power amplifier 204 for amplifying a signal to be transmitted by the antenna, a low noise amplifier 206 for amplifying a signal received by the antenna, an integrated circuit (‘IC’) 208 for processing the radio frequency (‘RF’) signals received and to be transmitted, a baseband processor 210 for processing the signals applied to and received from the RF IC, the keypad 112 and backlight 118, the display 114 and backlight 116 and the camera 120. The modules 200 also include a power supply 212 supplying power to the other elements of the module 200, and controlled by the baseband processor 210, in particular to control the supply of power to the backlights 116 and 118.

FIG. 3 shows a processor unit 300 of the telephone 100, and in particular of the baseband processor 210, which controls the power supplied to the luminescent panels 116 and 118 in accordance with one embodiment of the invention. The processor unit 300 comprises an image processor and camera memory 302, which processes signals from the image sensor 124 of the camera 120 and produces a digital electrical image signal representative of an image sensed by the image sensor, the digital image signal being stored in the camera memory for subsequent reproduction of the image.

In this embodiment of the invention, the telephone 100 also includes sensors responsive to ambient variables relating to usage of the device. More specifically, the telephone includes a light sensor 126 which senses the intensity of ambient light and the processor unit 300 includes a light sensor management component 304 for activating and deactivating the light sensor and processing the signal from the light sensor to produce a digital ambient light signal.

The telephone also includes another sensor responsive to an ambient variable relating to usage of the device in the form of a movement sensor 128 which responds to movement of the telephone 100 and the processor unit 300 includes a movement sensor management component 306 for processing the signal from the movement sensor to produce a digital movement signal. In one alternative, the movement sensor 128 comprises a suspended inertial mass that moves to connect and disconnect contacts electrically when the telephone moves, so as to produce signals indicative of the event of a movement. In another alternative, the movement sensor 128 comprises an accelerometer that produces a signal representative of the amplitude and speed of any movement of the telephone.

The telephone also includes an array of light emitting diodes (‘LED’) (not shown) that can be actuated as a flashlight for the camera 120 and also as a torch, and the processor unit 300 includes a flash LED management component 308 for controlling the operation of the flash LED.

The processor unit 300 also includes a timer 310 for timing delays and time intervals triggered by various events and a control unit 312 responsive to the conjunction of signals from the human interface actuators, the sensors and the timer. The control unit 312 drives a backlight management unit 314 which controls a backlight power supply component 316 in the power IC 212 to extinguish and reactivate the backlight luminescent panels 116 and 118 and control the intensity of illumination of the luminescent panels 116 and 118, whereby to economise power consumption of the luminescent panels when the conjunction of signals is indicative of partial or total inactivity of the telephone. The activation and deactivation of the backlight luminescent panels is a function not only of actuation or not of a key of the keypad 112, and/or of intervals timed by the timer, but also of ambient variables relating to usage of the telephone 100, in particular the ambient light and/or the movement of the telephone. The backlight panels may be switched ON and OFF abruptly or gradually. The control economises energy by switching OFF the backlight panels when the conjunction of events corresponds to user inactivity of the telephone.

In addition, the control unit 312 and the backlight management unit 314 control the brightness of the backlight luminescent panel 116 by modulating progressively the brightness of the luminescent panel as a function of the brightness of ambient light as sensed by the light sensor 126. In this embodiment of the invention, the luminescence controller function of the backlight management unit 314 is ensured by the backlight power control unit 312. In one implementation, the backlight intensity is controlled by hardware in the power IC 212 and/or in the baseband processor 210. In another implementation, the backlight intensity is controlled by software code from the baseband processor 210, which sends commands to the power drivers in the power management IC 212. In both of these implementations, the backlight intensity is controlled by causing the backlight power component to supply pulsed power to the luminescent panels 116 and 118 with duty cycles that vary in order to modulate progressively the brightness of the luminescent panels.

In this embodiment of the invention, the brightness of the keypad backlight luminescent panel 118 is not modulated progressively as a function of the brightness of ambient light, the panel being merely switched OFF when the ambient light intensity sensed is greater than a threshold and switched ON when the ambient light intensity sensed is lower than the threshold. However, in another embodiment, when the backlight luminescent panel 118 is switched ON below the threshold of ambient light intensity, its brightness is reduced progressively with reduced brightness of ambient light, when full brightness of the keypad illumination is unnecessary.

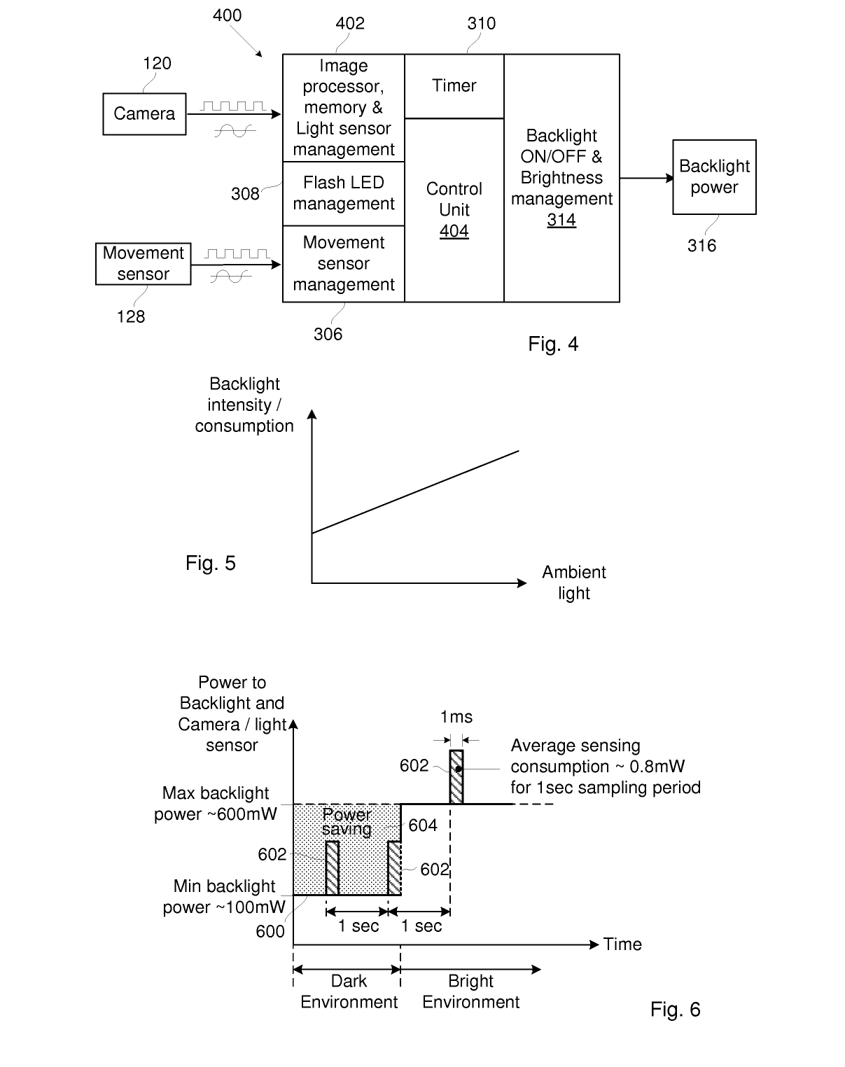

FIG. 4 shows another embodiment of the invention in which ambient light is sensed by sampling the signal from the image sensor 124 of the camera 120 during periods when the camera is not being used to take pictures. In this embodiment of the invention, a separate ambient light sensor is unnecessary. In this embodiment of the invention, the telephone 100 includes a processing unit 400 including an image processor, camera memory and light sensor management component 402 which, in addition to the camera image signal processing functions, activates and deactivates the sampling functions of the image sensor 124 and processes the ambient light sample signals from the light sensor to produce a digital ambient light signal representative of the intensity of the ambient light sensed by the image sensor 124. The processor unit 400 also includes a control unit 404 similar to the control unit 312, except that it responds to the ambient light sample signals from the image sensor 124 instead of to the light sensor 126.

FIG. 5 shows an example of the progressive modulation of the brightness of the luminescent panel 116 by the processing units 300 and 400 as a function of the brightness of ambient light. In this embodiment of the invention, the brightness of the luminescent panel is a smooth and continuous function of the brightness of ambient light. In other embodiments of the invention, the brightness varies stepwise as a function of the brightness of ambient light. In both cases, when the backlight is activated, its intensity increases with the intensity of ambient light, so as to increase the visibility of the display 114 in bright ambient light, while saving power and avoiding excessive brightness of the display in dimmer lighting conditions.

FIG. 6 shows power consumption of the backlight panels 116 and 118 (curve 600) and of the camera 120 and management component 402 (curve 602) as a function of time for an example of actuation of the camera 120 to sample ambient light in operation of the embodiment of FIG. 4. The camera 120 and the image processor, image memory and light sensor management component 402 both consume substantial quantities of power when activated. In this embodiment of the invention, the image sensor 124 and the image processor, image memory and light sensor management component 402 are activated only intermittently, at periodic intervals, to produce the sample signals representative of ambient light. In one example, they are activated during periods of 1 millisecond at intervals of 1 second as shown by the cross-hatched areas (not to scale). Accordingly, if their power consumption while activated is 0.8 watts, their average consumption during the ambient light sensing function is only 0.8 milliwatts. This contrasts with typical backlight power consumption of 100 mW minimum and 600 mW maximum. It follows that reducing backlight power consumption in a dark environment under the control of the sample signals from the camera 120 can lead to very substantial reductions in net power consumption as shown by the dotted area 604. Switching the backlight panels 116 and/or 118 OFF when ambient lighting conditions in conjunction with other criteria indicate user inactivity of the telephone gives even greater power saving.

The camera 120 is only used to sample ambient lighting during periods in which pictures are not being taken, notably when the image signal is not being stored in the camera memory. Since these periods are infrequent in use of telephones and most other portable devices, the lack of ambient light control of power consumption while pictures are being taken is not critical for battery life.

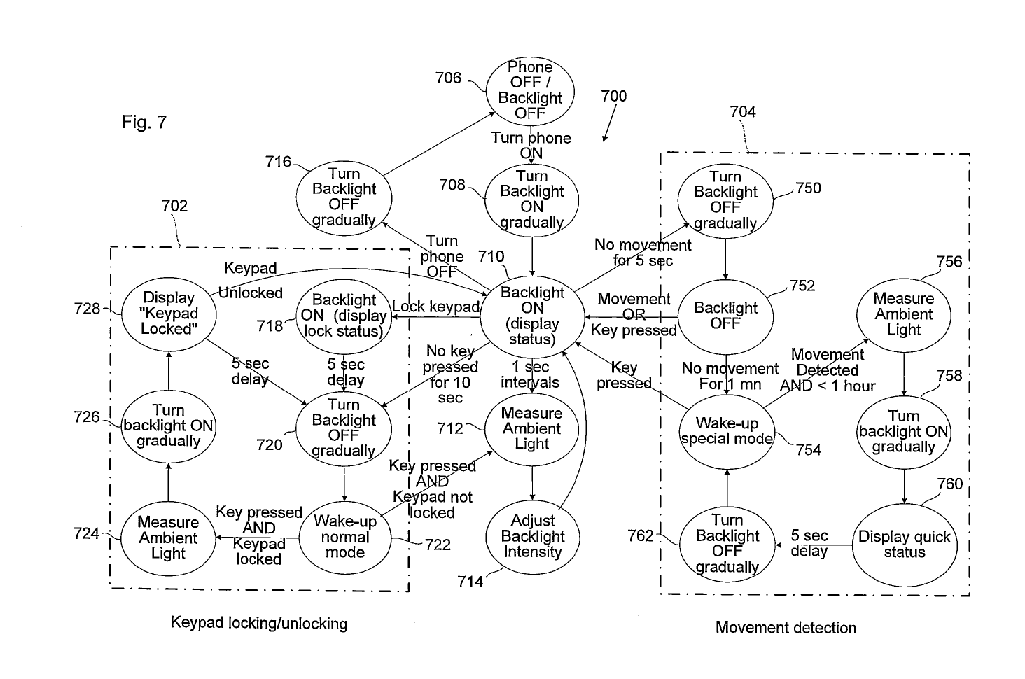

FIG. 7 shows a number of examples of conjunctions of criteria for controlling backlight activation/deactivation and intensity of the telephone of FIG. 4 in accordance with embodiments of the invention. Examples are given for basic functions of the telephone at 700, for responses to actions and absence of actions of keypad locking and unlocking and of key actuations of the telephone at 702 and for responses to detection or absence of movement of the telephone at 704.

In the basic functions 700, in the state shown at 706, the telephone is turned OFF and the backlights are switched OFF. When the telephone is switched ON, the backlight management unit 314 turns the backlight panels ON gradually at 708, so that their intensity increases progressively, and the telephone reaches the state shown at 710, where the backlight intensity is at the chosen intensity level and the panel 114 displays the status of the telephone. The control unit and light sensing management unit 402 measure the ambient light at 1 second intervals timed by the timer 310 as shown at 712 and the backlight intensity is controlled and adjusted if necessary as shown at 714 (the keypad backlight 118 being turned OFF if the ambient light is bright), the telephone then returning to the state 710.

When subsequently the telephone is switched OFF, the backlight management unit 314 turns the backlight panels OFF gradually at 716, so that their intensity reduces progressively to zero, and the telephone returns to the state at 706.

In the responses to actions and absence of actions of keypad locking and unlocking and key actuations of the telephone at 702, starting when the telephone is switched ON in the state shown at 710, if the user locks the keypad 112 the backlight 116 remains ON and the panel 114 displays the changed status of the telephone as shown at 718. After a 5 second delay timed by the timer 310, the backlight 116 (and the keypad backlight 118 if it was ON) is turned OFF gradually as shown at 720, the telephone then adopting a standby state in which its wake-up mode is normal as shown at 722. In the state shown at 710, if the keypad remains unlocked and no keypad action is detected during a lapse of time of 10 seconds timed by the timer 310, the backlight 116 (and the keypad backlight 118 if it was ON) is turned OFF gradually as shown at 720, the telephone adopting the standby state at 722 from which its wake-up mode is normal.

When in the standby state with normal wake-up mode at 722, if the keypad 112 is not locked and a key is actuated, the telephone assumes the condition 712 in which the control unit and light sensing management unit 402 measure the ambient light, the backlight intensity is adjusted if necessary as shown at 714 and the telephone reverts to the state 710 where the backlight intensity is at the chosen intensity level and the panel 114 displays the status of the telephone.

When in the standby state with normal wake-up mode at 722, if the keypad 112 is locked and a key is actuated, the light sensor 126 then measures the ambient light at 724, and the control unit 404 and light sensing management unit 402 turn the backlight 116 ON gradually as shown at 726 and the telephone adopts the state 728 where the backlight intensity is at the chosen intensity level and the panel 114 displays the ‘Keypad locked’ status of the telephone. If the user then unlocks the keypad 112, the telephone reverts to the state 710 where the backlight intensity is at the chosen intensity level and the panel 114 displays the status of the telephone. If, however, the user does not unlock the keypad within a lapse of time of 5 seconds timed by the timer 310, the backlight 116 is turned OFF gradually as shown at 720, the telephone returning to the standby state with normal wake-up mode at 722.

The functioning of the activation control unit 312 or 404 and backlight management unit 314 to the actions and absence of actions of keypad locking and unlocking and key actuations of the telephone illustrated at 702 are responsive to the conjunction of signals from human-interface actuators (the keys and keypad), a sensor responsive to an ambient variable relating to usage of the device (the light sensor 126) and the timer 310. However, the light sensor 126 only intervenes in the functions illustrated at 702 for adjusting the backlight intensity in response to the measurement of ambient light, not for switching the backlight ON and OFF, although this is the case in another embodiment of the invention.

The functioning of the activation control unit 312 and backlight management unit 314 illustrated at 704 are responsive to the conjunction of signals from a sensor responsive to an ambient variable relating to usage of the device (the movement sensor 128) in addition to the human-interface actuators (the keys and keypad), and the timer 310 to switch the backlight ON and OFF and further economise power consumption of the luminescent panel when the conjunction of signals is indicative of user inactivity of the telephone.

The activation control unit 312 and backlight management unit 314 do not respond to the movement detector if the telephone 100 is switched OFF, only if the telephone is ON or in standby. Starting from the state 710, where the backlight is ON and displays the status of the telephone, if the signal from the movement detector 128 indicates that there has been no movement at all of the telephone during an interval of 5 seconds as timed by the timer 310, the control unit 312 and backlight management unit 314 turn the backlight 116 (and the keypad backlight 118 if it was ON) gradually OFF, at 750. The telephone adopts the state shown at 752, where either detection of movement of the telephone by the detector 128 or actuation of a key of the keypad 112 will cause the control unit 312 and backlight management unit 314 to turn the backlights ON, the telephone reverting to the state 710. The conjunction of absence of key actuation and absence of movement detection leaves the telephone in the state 752.

However, from the state 752, if no movement is then detected during an interval of 1 minute as timed by the timer 310, the control unit 312 places the telephone in a standby state 754 with special wake-up mode. From the special wake-up standby state 754, if a key of the keypad 112 is actuated, the telephone returns directly to the state 710, where the backlight 116 is ON and displays the status of the telephone. Alternatively, even in the absence of keypad actuation, if the signal from the movement detector 128 indicates a movement of the telephone 100 within a lapse of time less than 1 hour, the backlight 116 is switched ON through a sub-routine in which the light sensor 126 then measures the ambient light at 756, and the control unit and light sensing management unit 402 turn the backlight ON gradually as shown at 758. The telephone then adopts the state 760 where the backlight intensity is at the chosen intensity level and the panel 114 displays the status of the telephone. This display is only temporary and, after a delay of 5 seconds timed by the timer 310, the control unit and light sensing management unit 402 turn the backlight OFF gradually as shown at 762, the telephone then reverting to the standby state 754 with special wake-up mode.

It will be appreciated that the conditionality of response to the conjunction of inactivity of human-interface actuators and absence of movement during a period defined by the timer to extinguish the luminescent panel makes it possible for the time-out to be shorter than it would otherwise be if the telephone is immobile, as occurs when it is placed on a table, for example. Response to the signal from the light sensor 126 gives additional power savings by reducing the luminescent panel power consumption when it is ON and can also be used to shorten time-out or add an additional criterion for switch OFF, if the light sensor indicates that the environment is so dark that the telephone 100 is not in use (in a bag for example), especially if the movement detector 128 and/or the absence of key actuation confirm the presumption of user inactivity.

In the above description, references to signals from the light sensor 126 of the embodiment of FIG. 3 will be replaced by references to signals from the camera 120 and the light sensor processor 402 when considering the functioning of the embodiment of FIG. 4.

The expression user activity of the telephone refers to intervention of the user, either on human-interface actuators such as the keypad or to communicate using the telephone or use other functions, such as consulting the clock or other display of the telephone. It will be appreciated that such user activity usually involves movement of the telephone 100 and changes in ambient light as detected by the telephone. By contrast, the expression user inactivity of the telephone refers to an absence of such intervention of the user, although the electronic signal processing modules 200 of the telephone may still be active, for example to receive communications, without any intervention of the user.

The embodiments of the invention have been described with reference to a telephone in which the luminescent panel 116 is a backlight panel for illuminating the display 114. The invention is also applicable to an embodiment in which the luminescent panel controlled is itself a display panel, such as an array of light emitting diodes controlled to display data.

The embodiments of the invention have been described with reference to a telephone. However, it will be appreciated that the invention is also applicable to other portable devices, for example cameras and personal digital assistants.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system. The computer program may be provided on a data carrier, such as a CD-rom or diskette, stored with data loadable in a memory of a computer system, the data representing the computer program. The data carrier may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few. Such computer readable media may be permanently, removably or remotely coupled to an information processing system

In the foregoing specification, the invention has been described with reference to specific examples of embodiments of the invention. It will, however, be evident that various modifications and changes may be made therein without departing from the broader spirit and scope of the invention as set forth in the appended claims. For example, the connections may be an type of connection suitable to transfer signals from or to the respective nodes, units or devices, for example via intermediate devices. Accordingly, unless implied or stated otherwise the connections may for example be direct connections or indirect connections. However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

1. A portable device Comprising:
at least one luminescent element:
a camera including an image sensor for activation to produce an electrical image signal representative of an image sensed by the image sensor;
a camera signal processor including a camera memory for storing said image signal for subsequent reproduction of said image;
a luminescence controller for controlling a brightness of said luminescent element;
wherein said camera signal processor is also arranged to activate said image sensor intermittently to produce sample signals representative of ambient light during periods in which said image signal is not being stored in said camera memory, said luminescence controller being responsive to said sample signals to control the brightness of said luminescent element as a function of a brightness of ambient light.

2. A portable device as claimed in claim 1, wherein said luminescence controller is responsive to said sample signals to modulate progressively the brightness of said luminescent element as a function of a brightness of ambient light.

3. A portable device as claimed in claim 1, also comprising a user interface application, and a display including said luminescent element operable to display an image derived from said image signal and/or data relating to said user interface application, wherein at least while said data relating to said user interface application is displayed said luminescence controller is responsive to said sample signals to modulate progressively said brightness of said luminescent element, whereby to control a brightness of display of said data as a function of a brightness of ambient light.

4. A portable device as claimed in claim 3, wherein said display comprises a display screen and said luminescent element includes a luminescent panel juxtaposed behind said display screen as a backlight.

5. A portable device as claimed in claim 3, wherein said luminescence controller is arranged to increase said brightness of said display in response to a value of said electrical image signal indicative of increased brightness of ambient light.

6. A portable device as claimed in claim 1, also comprising a keypad, at least one luminescent panel being juxtaposed behind said keypad as a backlight, wherein said luminescence controller is responsive to said sample signals to control a brightness of illumination of said keypad as a function of a brightness of ambient light.

7. A portable device as claimed in claim 1, wherein said luminescence controller is arranged to supply pulsed power to said luminescent element with a duty cycle that varies in order to modulate progressively the brightness of said luminescent element.

8. A portable device comprising:
at least one luminescent element;
a plurality of human-interface actuators, at least one sensor responsive to an ambient variable relating to usage of the device;
a timer and an activation controller for controlling activation and deactivation of said luminescent element;
wherein activation controller is responsive to different conjunctions of signals from said actuators, said sensor and said timer to activate selectively said luminescent element and to extinguish said luminescent element, when said conjunction of signals is indicative of user inactivity of said device.

9. A portable device as claimed in claim 8, wherein said at least one sensor comprises a movement sensor, and said activation controller is responsive to the conjunction of inactivity of said actuators and absence of movement of said device during a period defined by said timer to extinguish said luminescent element, said activation controller being responsive to a subsequent signal from said actuators or from said movement sensor to reactivate said luminescent element.

10. A portable device as claimed in claim 9, wherein said movement sensor comprises an accelerometer, and said activation controller is responsive to the conjunction of inactivity of said actuators and absence of acceleration during a period defined by said timer to extinguish said luminescent element, said activation controller being responsive to a subsequent signal from said actuators or from said accelerometer to reactivate said luminescent element.

11. A portable device as claimed in claim 8, wherein said at least one sensor comprises a light sensor responsive to a brightness of ambient light, and said activation controller is responsive to the conjunction of inactivity of said actuators and absence of ambient light during a period defined by said timer to extinguish said luminescent element, said activation controller being responsive to a subsequent signal from said actuators or from said light sensor to reactivate luminescence of said luminescent element.

12. A portable device as claimed in claim 11, comprising a camera comprising an image sensor for activation to produce an electrical image signal representative of an image sensed by the image sensor, and a camera signal processor including a camera memory for storing said image signal for subsequent reproduction of said image, wherein said light sensor comprises said image sensor and said camera signal processor is also arranged to actuate said image sensor intermittently to produce signal samples representative of ambient light during periods in which said image signal is not being stored in said camera memory.

13. A portable device as claimed in claim 12, wherein said luminescence controller is responsive to said sample signals to modulate progressively the brightness of said luminescent element as a function of a brightness of ambient light.

14. (canceled)

15. (canceled)

16. A portable device as claimed in claim 2, also comprising a user interface application, and a display including said luminescent element operable to display an image derived from said image signal and/or data relating to said user interface application, wherein at least while said data relating to said user interface application is displayed said luminescence controller is responsive to said sample signals to modulate progressively said brightness of said luminescent element, whereby to control a brightness of display of said data as a function of a brightness of ambient light.

17. A portable device as claimed in claim 4, wherein said luminescence controller is arranged to increase said brightness of said display in response to a value of said electrical image signal indicative of increased brightness of ambient light.

18. A portable device as claimed in claim 2, also comprising a keypad, at least one luminescent panel being juxtaposed behind said keypad as a backlight, wherein said luminescence controller is responsive to said sample signals to control a brightness of illumination of said keypad as a function of a brightness of ambient light.

19. A portable device as claimed in claim 3, also comprising a keypad, at least one luminescent panel being juxtaposed behind said keypad as a backlight, wherein said luminescence controller is responsive to said sample signals to control a brightness of illumination of said keypad as a function of a brightness of ambient light.

20. A portable device as claimed in claim 9, wherein said at least one sensor comprises a light sensor responsive to a brightness of ambient light, and said activation controller is responsive to the conjunction of inactivity of said actuators and absence of ambient light during a period defined by said timer to extinguish said luminescent element, said activation controller being responsive to a subsequent signal from said actuators or from said light sensor to reactivate luminescence of said luminescent element.

21. A portable device as claimed in claim 2, wherein said luminescence controller is arranged to supply pulsed power to said luminescent element with a duty cycle that varies in order to modulate progressively the brightness of said luminescent element.

22. A portable device as claimed in claim 3, wherein said luminescence controller is arranged to supply pulsed power to said luminescent element with a duty cycle that varies in order to modulate progressively the brightness of said luminescent element.
